(19) United States
(12) Patent Application Publication
(10) Pub. No.: US 2017/0043239 A1
(43) Pub. Date: Feb. 16, 2017

(54) SUPPORT POLE FOR PROTECTION NETS OF A SKI SLOPE, WITH MARKER MEANS FOR MARKING THE DEPTH AT WHICH THE SUPPORT POLE IS DRIVEN INTO THE SNOW, AND CORRESPONDING PROTECTION NET FOR SKI SLOPES

(71) Applicant: S.P.M. S.p.A, Brissago (VA) (IT)

(72) Inventor: Giovanni BERUTTI, Germignaga (VA) (IT)

(21) Appl. No.: 15/227,006

(22) Filed: Aug. 3, 2016

(30) Foreign Application Priority Data
Aug. 11, 2015 (IT) 202015000043852

(51) Int. Cl. A63C 19/08; E01F 13/02; E04H 17/08; G09F 3/00; E04H 17/04

(52) U.S. Cl. CPC A63C 19/08; G09F 3/00; E04H 17/04; E04H 17/08; E01F 13/028; A63C 2019/085

(57) ABSTRACT

A useful and practical support pole (10) for supporting protection nets (20) installed for safety purposes along the edge of a ski slope (PS), characterized by marker elements (15, 15′, 15″) adapted to mark a predetermined depth (P) at which the support post (10) has to be properly driven into the snow pack (MN) of the ski slope (PS) for proper and optimized positioning of such support pole (10) as it is driven into the snow for supporting the protection net (20). Advantageously, the support pole (10) and the corresponding protection net (20) supported by such poles driven into the snow obviate certain non-negligible drawbacks of prior art currently used protection nets for ski slopes and particularly considerably reduce the risk of injury for the skier, as he/she hits these protection nets.

### FIELD OF THE INVENTION

The present invention patent generally relates to the field of safety systems and equipment, aimed at preventing and avoiding accidents during the practice of ski sports and more particularly relates to a novel and useful support pole for nets that are usually installed for safety and protection purposes along the edges of ski slopes and skiing courses to stop and retain the skier when he/she swerves and does not properly follow the intended course, to prevent the skier from going out of the ski slope and be exposed to serious injuries affecting his/her health, e.g. by hitting obstacles such as trees, rocks, pylons and else, or by falling off a precipice.

The invention patent also relates to a corresponding protection net, that has been or is to be installed along the edge of a ski slope, comprising and supported by a plurality of support plates adapted to be driven into the snow pack of the ski slope.

### CROSS-REFERENCE TO RELATED APPLICATIONS

It should be noted that the Applicant has been committed for a long time to research and testing of novel solutions and new products to increase the safety, accessibility and attractiveness of ski sports, practiced both at competition level and simply for leisure, and filed, on 23 Jul. 2014, in the same technical field of the present invention patent, a prior patent application for a utility model No. MI2014U000235 whose title was: “PORTA PER LO SPORT DELLO SCI CON MEZZI INDICATORI DELLA POSIZIONE DEL RISPETTIVO TELO” (Gate for ski sports with indicator means for indicating the position of its panel).

Particularly, this prior utility model relates to a gate for ski sports, consisting of two poles driven into the snow and joined at their top by a panel, for indicating and tracing the path to be followed by a skier on a ski slope, wherein such ski gate is characterized by indicator means, associated with the respective two poles, having the purpose of indicating a predetermined height of the top panel of the gate relative to the snow pack of the ski slope, and then allow proper height positioning of the gate panel, particularly in compliance with applicable standards and regulations for ski sports, when the gate is driven into the snow pack.

The indicator means, associated with the poles of the gate may take various forms, such as a white or colored band, text, a band combined with text, or other forms, and be provided in various locations along the axial extent of the poles to indicate the predetermined height of the gate panel relative to the snow pack.

Since the present invention patent is an interesting and advantageous improvement that implements the technical principle of the prior utility model in a new form, direct reference may be made to such prior utility model patent application by the Applicant hereof for any additional information and data that might be useful to supplement and clarify the contents of the present new invention patent application.

### BACKGROUND OF THE INVENTION

Ski slopes have been commonly known for many years to be fenced at their sides by appropriate protection nets, to prevent skiers that fall or lose control of their athletic movements, from coming out of the ski slope and fall off precipices and/or hit obstacles such as trees, rocks, pylons, etc.

Two main types of protective nets are currently used: fixed and removable nets.

The fixed protection net arrangement, which is known in the art as “A Type net”, is obtained by installing large metal poles along the edge of the ski slope, and attaching nets of thermoplastic braid thereto.

These structures are typically installed at the start of the Winter season and remain in use throughout the season.

Typically, the nets for these structures are as high as 4 meters.

For clarity, the photographic pictures of FIGS. 3A-3C show some of these A Type structures or nets of the prior art.

The removable protection net arrangement, known in the art as “B Type net”, is typically used to create temporary protections, e.g. in case of competition events that last a few days.

The protection net is installed before the competition in areas of the course that are deemed to be particularly dangerous for the skier, and is later removed at the end of the competition, and consists of a series of plastic poles that are driven into the snow at a distance of 1.5+2 meters from each other, with a typically 2-meters high net attached thereto.

These nets are formed and connected by sections as long as 15+20 meters, to obtain a seamless protection that can extend over hundreds of meters.

In most cases multiple nets, e.g. two or three, and in certain cases even four, are adjacently positioned one behind the other, so that the skier will successively hit more than one net, which will reduce his/her speed and stop him/her over a space that is large enough as to limit impact-associated trauma.

For clarity, the photographic images of FIGS. 4A-4C show a few exemplary embodiments of these removable B Type protection nets, successively arranged one behind the other, according to the prior art.

The basic element for the operation of B Type nets is the plastic support pole upon which the protection net is designed to be attached.

In this respect, manufacturers currently provide two kinds of arrangements, as explained below, i.e. net supporting poles with or without a stress raising slot.

a) Net Supporting Poles with Stress Raising Slot

In this arrangement, a peripheral slot is formed in the lower portion of the pole, i.e. level with snow, to reduce the resistance of the pole.

Therefore, when the skier hits the protection net supported by these poles that have been driven into the snow, the pole is weakened by the slot and breaks. In practice, during the impact multiple poles are broken, whereby the protection net is configured and reacts as a sort of “bag” that receives and stops the skier as he/she hits it.

Nevertheless, this arrangement suffers from certain limitations and drawbacks, one of which is that, if the pole is not properly positioned and driven into the snow, i.e. if it is placed at the wrong depth and with the slot above the snow level, when the skier hits the protection net, the pole will not break level with the snow but at a higher level, and the stump of the broken pole that projects out of the snow will be a serious hazard for the skier.

b) Net Supporting Poles without Stress Raising Slot

This arrangement is employed by most manufacturers, and is the most widespread.

When the skier hits the protection net, the poles are bent and deformed until they come out of their seat, while absorbing, in cooperation with other elements, e.g. the effect of a simultaneous deformation of the net, the energy of the impact, thereby reducing the speed of the skier and stopping him/her, possibly also by the action of the second and third protection nets arranged one behind the other.

In the latter arrangement with support poles without a stress raising slot the depth at which the pole is positioned and driven into the snow is once again of critical importance.

During impact of the skier against the protection net, when the pole is stressed toward ejection from the hole in which it has been plunged and driven into the snow, a significant amount of the impact energy that is absorbed and dissipated depends on the amount of friction forces generated between the portion of the pole that is plunged in the snow and the snow itself, and hence on the depth at which the pole has been driven into the snow.

As a result, if the pole/s have been driven into the snow to an excessive extent, these friction forces will be higher and will tend to limit the ability of the support pole/s to bend and yield relative to the snow pack, whereby the protection net will also tend to be rigid, i.e. have little compliance, and the skier will be at risk of incurring excessive trauma upon impact thereagainst.

Conversely, if the pole/s have been driven into the snow to an insufficient extent, these friction forces will be lower, whereby the pole/s and the protection net will have an excessive compliance and will not be able to adequately absorb the energy of impact of the skier against the protection net.

Therefore, there is a critical need for the pole to be properly positioned and driven into the snow, i.e. within an optimal range of driving depths.

### SUMMARY OF THE INVENTION

Therefore, the main object of the present invention patent is to conceive and provide a novel support pole, for use with protection nets designed to be installed along the edge of a ski slope, that can considerably improve the performance and effectiveness of currently known and used protection nets, particularly in terms of higher safety and lower risk of injury for the skier that hits them.

Another object of the present invention patent, which is also associated with the previous object, is to provide a protection net for ski slopes that can be easily and quickly installed in the proper manner along the edge of the ski slope, with no risk of mounting and positioning errors by the personnel, that might affect performances and safety in case of impact of the skier thereagainst.

These objects may be deemed to be completely fulfilled by the support pole for ski protection nets having the characteristics as set forth in the independent claim 1 and by the protection net having the characteristics as claimed in claim 7.

Particular embodiments of the support pole for protection nets of a ski slope and the respective protection net for ski slopes are also defined by the dependent claims.

As better explained hereinafter, the new pole of the present invention patent, for supporting protection nets designed to be installed for safety purposes along ski slopes, and the corresponding protection net for ski slopes, provide many considerable advantages, as partially mentioned above, and by way of example the following advantages:
the protection net can effectively stop the skier as he/she hits it, while preventing him/her to incur trauma;
the risk that the health of the skier might be affected by an impact against the protection net will accordingly be considerably reduced;
the protection net is mounted and set up in very short times;
the cost of the support pole and the respective protection net is substantially comparable to that of conventional poles and protection nets, in spite of their improved characteristics in terms of safety and protection effectiveness.

### BRIEF DESCRIPTION OF THE DRAWINGS

These and other objects, features and advantages of the present invention patent will clearly and apparently result from the following description of a preferred embodiment thereof, which is given by way of non-limiting example with reference to the annexed drawings, in which:

FIG. 1 shows a support pole of the present invention patent for supporting protection nets designed to be installed, for safety purposes, along the edge of a ski slope;

FIG. 1A shows a variant of the support pole of FIG. 1, according to the present invention patent;

FIGS. 2A-2C show enlarged views of certain areas and details, outlined by a circle, of the support pole of FIG. 1, comprising marker means for marking the proper depth at which the support pole has to be driven into the snow pack of the ski slope;

FIGS. 3A-3C are photographic pictures of Type A protection nets according to the prior art, designed to be installed for safety reasons along the edges of a ski slope; and

FIGS. 4A-4C are photographic pictures of Type B protection nets according to the prior art, designed to be installed for safety reasons along the edges of a ski slope.

### DESCRIPTION OF THE PREFERRED EMBODIMENTS

Referring to the drawings, a support pole of the present invention patent, which is designed for use in supporting a protection net or barrier that has been or is to be installed, for safety purposes, along the edge of a ski slope, is generally referenced 10.

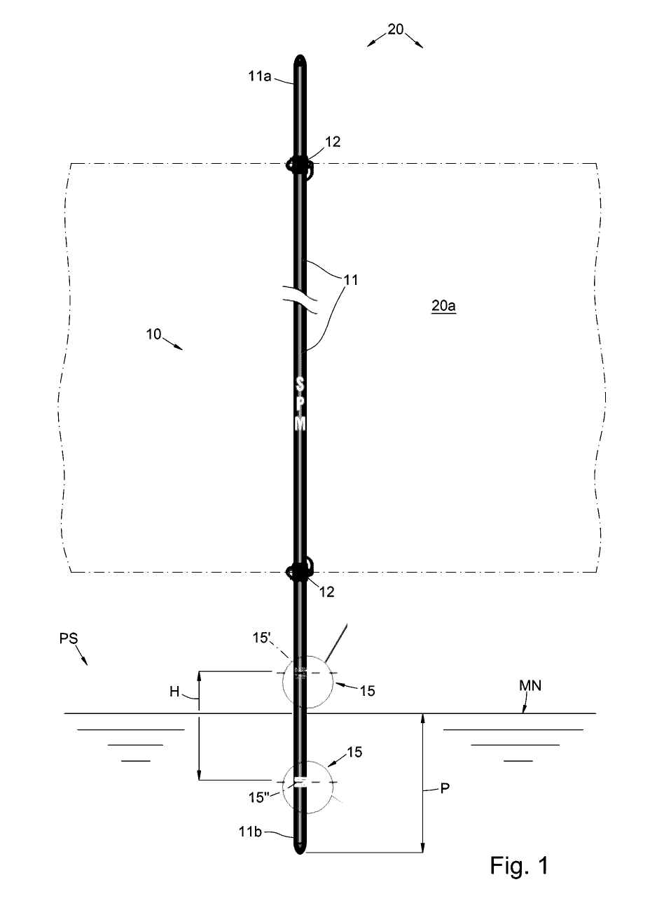

The support pole 10, as shown in detail in FIG. 1, is composed of a vertically extending shaft 11 having an upper tip 11a and a lower tip 11b, the latter being designed to be plunged and driven into the snow pack MN, along the edge of a ski slope, generally referenced PS.

Once the pole 10 has been plunged and driven into the snow pack MN, it will have, as mentioned above, the purpose of supporting a protection net, generally referenced 20, and comprising a respective panel 20a, as shown by a one-dot chain line in FIG. 1.

For this purpose, the support pole 10 comprises suitable anchors, having known characteristics, referenced 12 and placed at suitable heights along the vertical extend of the shaft 11, for attaching the panel 20a of the protection net 20.

The shaft 11 of the support pole 10 is in turn made of a material, usually a plastic material, that exhibits some resilience, such that the support pole 10 is allowed to be appropriately deformed and bent when a skier hits the protection net 20 borne and supported by the support pole 10.

The panel 20a of this protection net 20, that is designed to be attached by the anchors 12 to the support pole 10, has substantially known characteristics, i.e. complying with the types of panels and similar items as used for setting up safety nets and barriers along the edges of ski slopes, and will not be described in detail.

For example, this panel 20a may consist of a common plastic sheet, with or without holes, or a similar net, implying low manufacturing costs, and further has good elasticity and deformability, such that it may have an effective damping and energy-absorbing effect when a skier hits the protection net 20 and is this retained by its panel 20a.

According to a peculiar feature of the invention patent, the support pole 10 comprises marker means, generally referenced 15, for marking a predetermined depth or a predetermined depth range at which the support pole 10 has to be suitably and properly driven into the snow pack MN of the ski slope PS, to thereby facilitate and allow proper positioning of the support pole 10, as it is driven into the snow, and hence an optimal and proper operation of the protection network supported by such support pole 10, to stop and retain the skier that runs against it.

For instance, as shown in FIG. 1, these marker means 15 preferably comprise an upper marker and a lower marker 15′, 15″, defined along the axial length of the shaft 11 of the pole 10, which are designed to mark the maximum level, i.e. the maximum depth, and the minimum level, i.e. the minimum depth at which the support pole 10 has to be driven into the snow to properly and optimally provide both support to the protection net 20 and help to absorb the impact energy of a skier as he/she hits the protection network 20. Thus, the two markers 15′ and 15″ define a predetermined range, referenced H in FIG. 1, for the depth P at which the lower tip 11b of the support pole 10 has to be driven into the snow, for allowing the support pole 10 and the respective protection network 20 to operate properly.

As a result, with these marker means 15 associated with each support pole 10, anyone passing by the protection network 20, e.g. those in charge with the safety of the ski slope, will be able to easily check at a glance whether the protection network 20 and its support poles 10 have been properly installed, by simply checking whether the markers 15′ and 15″ in the support poles 10 are visible.

Particularly, if both markers 15′ and 15″ are visible, this will mean that the support pole 10 has been plunged and driven into the snow at an inadequate depth, whereas if none of the markers 15′ and 15″ is visible, this will mean that the pole 10 has been plunged and driven into the snow at an excessive depth, and also, if only the upper marker 15′ is visible, this would mean that the pole 10 has been properly plunged and driven into the snow.

Since the worst hazard for the skier that hits the protection net 20 occurs when the support pole is driven into the snow at an inadequate depth, which makes the protection network 22 too weak and yielding, and prevents it from absorbing the impact energy of the skier to a sufficient extent, a simpler but effective variant of the support pole 10 of the invention patent as described above is the one shown in figure la and referenced 10′ which consists in only providing the marker 15″ of the minimum level or depth Pmin at which the pole 10′ must be driven into the snow.

Therefore, in this variant 10′ of the support pole, which also defines a corresponding variant 20′ of the protection net, a visual check by the personnel, determining that the marker 15′ is placed exactly at or not far from snow level, or is hidden, ensures that the support pole 10′ has been properly driven into the snow pack MN to a sufficient extent, i.e. at least at a minimum depth Pmin.

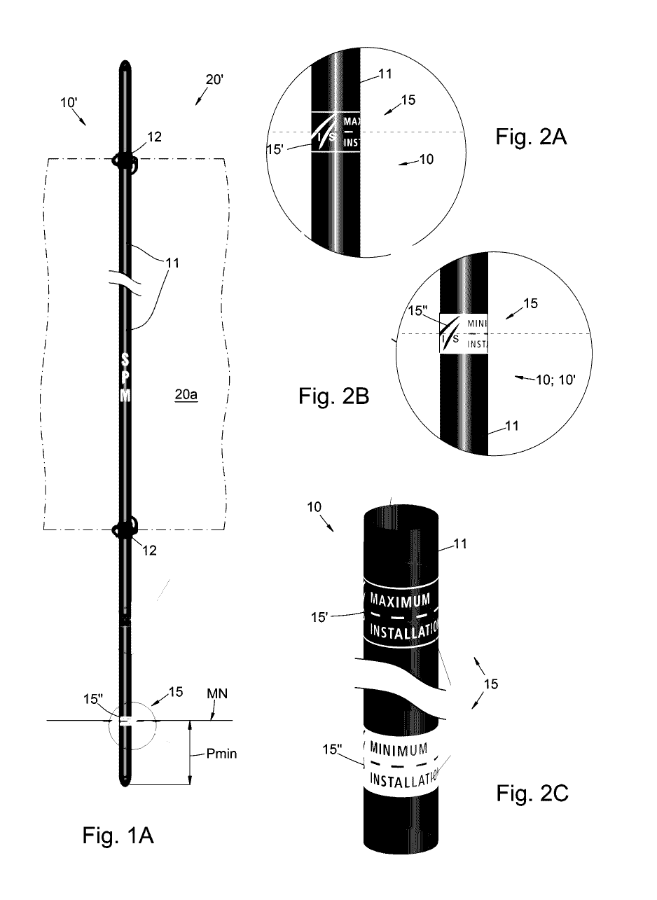

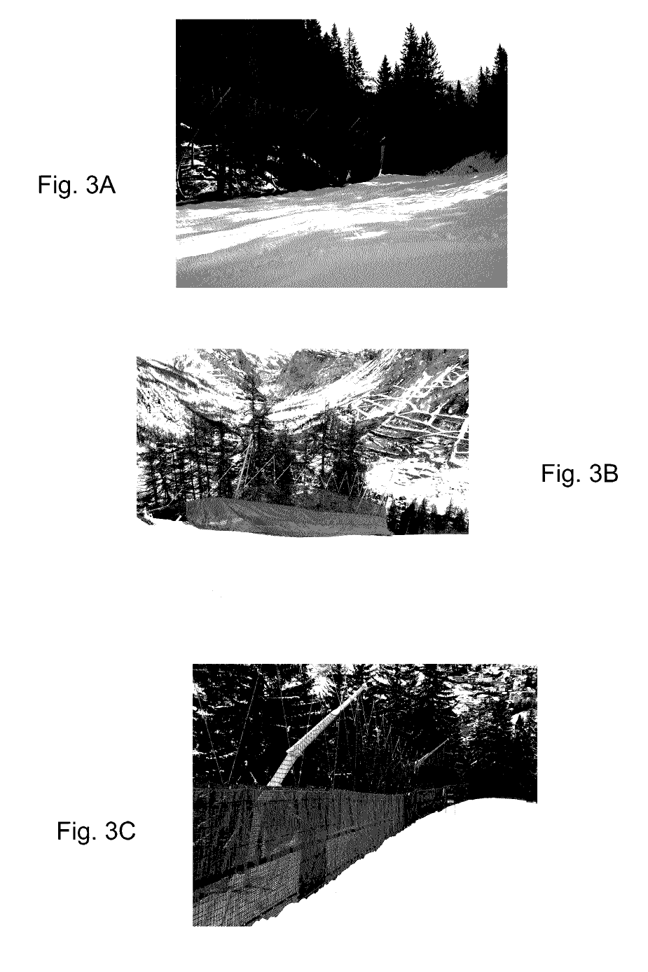

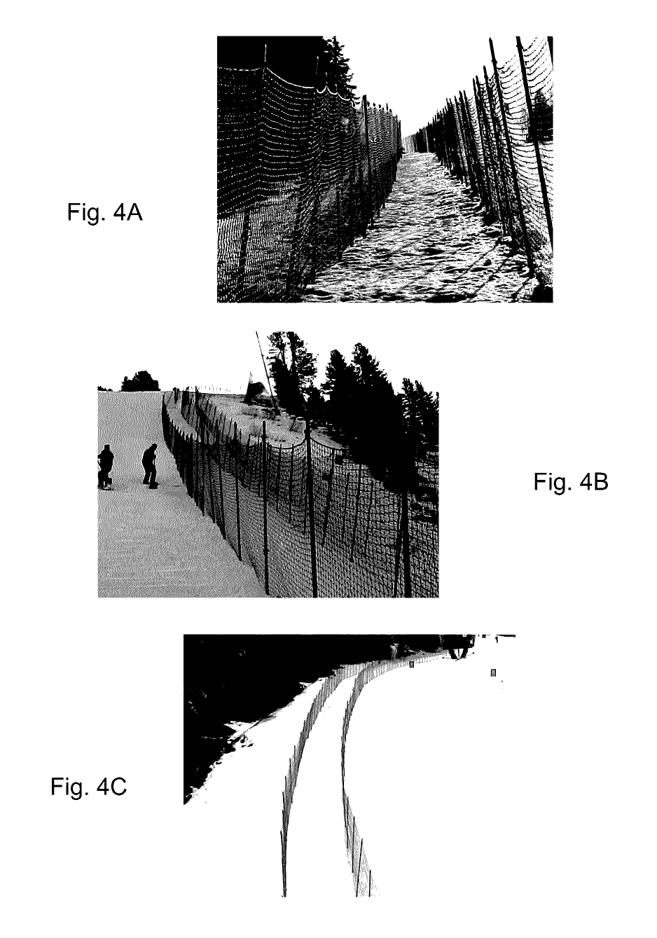

FIGS. 2A, 2B, 2C show enlarged detail views of some examples of these marker means 15 and their respective markers 15′ and 15″ formed along the axial length of the pole 10 or 10′.

Preferably, the markers 15′ and 15, marking the maximum and minimum depth levels respectively at which the support pole 10 can be driven into the snow, are defined differently, and may be embodied in different forms and with different techniques.

For example, the markers 15′ and 15″ may be provided in the form of a simple white or colored band, or text, such as “FIS recommended minimum /maximum snow level” or other forms with similar meanings.

Otherwise, the markers 15′ and 15″ may consist of band combined with text, like in the illustrated example.

Also, the marker means 15 and their respective markers 15′ and 15″ may be tangibly embodied in different forms and using different techniques, for example:
silk-screen printing or the like;
adhesive application; or
direct engraving of a text or a sign on the surface of the shaft 11 of the support pole 10 or 10′; or
other technical methods.

For example, assuming a support pole 10 or 10′ whose total height is about 256 cm, in compliance with current regulations for protection nets or barriers supported by these poles 10 and 10′, the respective marker means 15 and markers 15, 15′ may be configured to mark a minimum depth of about 20 cm and a maximum depth of about 50 cm respectively, at which the support poles are required to be driven into the snow, which will involve a range H of about 30 cm for such depth

For operation of the support poles 10, when a protection net 20 is required to be installed for safety reasons along the edge of a ski slope, the support poles 10 designed to support such protection net 20 are driven into the snow by the personnel at the proper depth, or within the proper depth range, i.e. following the indications of the markers 15′ and 15″ of the marker means 15 of each pole 10.

Then, the protection panel 20a is mounted to the poles 10 that have been driven into the snow, which thereby can bear and support the protection net 20, once it has been installed.

Therefore, should a skier hit the protection net 20, the support poles 10 of the latter, which have been driven into the snow at the proper depth, will bend and react in a proper and optimal manner to damp the impact of the skier, thereby preventing the skier to incur health risks.

Therefore, the above disclosure clearly shows that the present invention patent completely fulfills the intended objects, and particularly provides a novel and useful pole to supporting protection nets for ski slopes, which, in addition to being able to bend and effectively operate to damp and absorb the impact energy caused by a skier that hits the protection net, also advantageously allows the personnel, during installation of the protection net, to properly position and drive the support pole into the snow pack without the risk of making errors, in view of optimal operation of the protection net in terms of damping the impact of the skier thereagainst.

Furthermore, as an additional advantage, the support pole of the invention patent allows those in charge of the safety of the ski slope to easily and immediately check at a glance whether the pole has been properly installed and driven into the snow, to thereby be able to properly and optimally cooperate with the protection net to damp and absorb the impact energy caused by the impact of the skier against the protection net, with no risk for the health of the skier.

Also, it shall be appreciated that the marker means associated with the support pole will not only allow the pole to be positioned and driven into the snow in the proper and optimal manner and at the proper and optimal depth, during installation of the protection net, but will also allow an easy visual check to ascertain whether the pole have moved with time from its initial proper position, and take actions, if needed, to restore it to its proper position.

1. A support pole (10; 10′) for protection nets (20) that are designed to be or are installed for safety purposes along the edge of a ski slope (PS), wherein said support pole (10; 10′) comprises marker means (15, 15′, 15″) adapted to mark a predetermined depth (P, H) at which the support post (10) has to be properly driven into the snow pack (MN) of the ski slope for proper and optimal positioning of such support pole (10) as it is driven into the snow for supporting the protection net (20) of the ski slope (PS).

2. A support pole (10; 10′) as claimed in claim 1, wherein said marker means (15) comprise at least one marker (15″) defined along the axial length of the support pole, to mark a minimum depth (Pmin) at which the support pole (10; 10′) has to be properly driven into the snow pack (MN).

3. A support pole (10) as claimed in claim 1, wherein said marker means (15) comprise at least two markers (15, 15′) defined along the axial length of the support pole, to mark a minimum depth and a maximum depth respectively and hence a predetermined depth range (H) at which the support pole (10) has to be properly driven into the snow pack (MN).

4. A support pole (10, 10′) as claimed in claim 1, wherein said marker means (15, 15′, 15″) may be provided in various forms along the axial extent of the support pole (10, 10′) and particularly in the form of a simple white or colored strip or band, text, or a band combined with text.

5. A support pole (10) as claimed in claim 1, wherein said marker means (15, 15′, 15″) are formed using various technologies and methods along the axial extent of the support pole (10) and particularly by silk-screen printing, adhesive application, direct engraving of text on the surface of the pole, or other similar operations and techniques.

6. A support pole (10, 10′) as claimed in claim 1, wherein, assuming a support pole whose total height is about 256 cm, said marker means and their respective markers (15, 15′, 15″) are configured to mark a minimum depth of about 20 cm and a maximum depth of about 50 cm, at which the support pole (10, 10′) is required to be driven into the snow, which will involve a range (H) of about 30 cm for such depth (P).

7. A protection net (20, 20a; 20′) that is designed to be or is installed for safety purposes along the edge of a ski slope, comprising a plurality of support poles (10; 10′) as claimed in claim 1, for supporting such protection net (20;
20′) for a ski slope.

8. A multiple protection net for a ski slope, comprising a plurality of protection nets as claimed in claim 7, adjacently arranged one behind the latter, to be adapted to successively receive the skier that hits said multiple protection net.

9. A support pole (10, 10′) as claimed in claim 2, wherein said marker means (15, 15′, 15″) may be provided in various forms along the axial extent of the support pole (10, 10′) and particularly in the form of a simple white or colored strip or band, text, or a band combined with text.
